(19) United States
(12) Patent Application Publication
(10) Pub. No.: US 2001/0042006 A1
(43) Pub. Date: Nov. 15, 2001

(54) METHOD AND APPARATUS FOR TARGETING ADVERTISING IN OVERLAPPING SALES TERRITORIES

(76) Inventors: LEO CHAN, BELMONT, CA (US); KING-SUN WAI, SANTA CLARA, CA (US)

Correspondence Address: CHARLES E SHEMWELL, BLAKELY SOKOLOFF TAYLOR & ZAFMAN LLP, 12400 WILSHIRE BOULEVARD, 7TH FLOOR, LOS ANGELES, CA, 90025

(21) Appl. No.: 09/282,751

(22) Filed: Mar. 31, 1999

(51) Int. Cl. G06F 17/60

(52) U.S. Cl. 705/14

(57) ABSTRACT

A method, apparatus, and article of manufacture for targeting information content, such as advertising, in overlapping sales territories. In one embodiment, a user accesses a web site and is assigned a cobrand. The cobrand is assigned based upon a uniform resource locator (URL) determined from data received from the user during access of the web site. If the determined URL does not correspond to a cobrand, the user is assigned an implicit cobrand. If the determined URL corresponds to a cobrand, the user is assigned an explicit cobrand. Advertising content based upon the assigned cobrand is selected and displayed to the user.

### FIELD OF THE INVENTION

The invention relates generally to networked computer systems and, more particularly, to a computerized method and apparatus for targeting information content in overlapping sales territories.

### BACKGROUND OF THE INVENTION

With the growth of Internet use for both information and commerce, businesses frequently seek to advertise products and services on a web site that has a high site access rate or a readership with particular characteristics. The advertisements are typically displayed to a user accessing the web site in response to initial access of the web site or in response to a search query of the web site. The web site owner may directly maintain and display the advertisements on the web site, or may provide a computer connection, or link, to another advertising provider that maintains and displays the advertisements.

The advertising provider usually has several other web site owners, or partners, who also advertise their products through the advertising provider. Often the different partners have overlapping sales territories and competing products that are advertised by the same advertising provider. As the readership of a web site is usually large and geographically wide spread, the advertising provider must ensure that advertising corresponding to the sales territory of one partner, and not the advertisements of its competitors, are displayed to a user accessing the advertising web site.

One known approach for ensuring that advertising corresponding to the sales territory of a partner is displayed to a user is for the advertising provider to establish a separate computer system for the advertising of each partner. Only advertisements for a particular partner will exist on the respective computer system. In this way, a user accessing a partner web site typically can be linked to the advertising company web site and advertising of the partner displayed to the user. Advertising using this method may be costly, as redundant systems may be used, and can be time consuming if numerous systems are established and maintained. Additionally, this method typically has little flexibility for promoting the advertisements of other partners should a particular partner not have any advertisements.

Therefore, there is a need for a method and/or apparatus for targeting advertising where overlapping sales territories exist.

### SUMMARY OF THE INVENTION

The present invention provides a method, apparatus, and article of manufacture for targeting information content, such as advertising, in overlapping sales territories. In one embodiment, a user accesses a web site and is assigned a cobrand. The cobrand is assigned based upon a uniform resource locator (URL) received during access of the web site. If the URL does not correspond to a cobrand, the user is assigned an implicit cobrand. If the URL corresponds to a cobrand, the user is assigned an explicit cobrand. Advertising content based upon the assigned cobrand is selected and displayed to the user.

### BRIEF DESCRIPTION OF THE DRAWINGS

The invention may best be understood by referring to the following description and accompanying drawings which are used to illustrate embodiments of the invention. In the drawings:

FIG. 1 illustrates one embodiment of a computer system 100 which implements the principles of the present invention;

FIG. 2 is a diagram 200 illustrating one context in which one embodiment of the present invention may be used for targeting advertising in overlapping sales territories;

FIG. 3 illustrates an example of an advertising table 300 according to one embodiment of the present invention;

FIG. 4 illustrates an example of a cobrand context file 400 according to one embodiment of the present invention;

FIG. 5 illustrates a flow diagram 500 of one embodiment of a method of the present invention which targets advertising in overlapping sales territories;

FIG. 6 illustrates a flow diagram 600 of one embodiment of a method of the present invention which targets advertising in overlapping sales territories; and

FIG. 7 illustrates a table 700 of one embodiment of the method of a present invention for selecting the advertising, e.g. an advertisement, to display to a user where competing cobrands are not excluded.

### DETAILED DESCRIPTION OF THE INVENTION

In the following description of a preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

In the following description, for purposes of explanation, numerous specific details are set forth in order to provide a thorough understanding of the present invention. It will be evident, however, to one skilled in the art that the present invention may be practiced without these specific details. In other instances, well-known structures and devices are shown in block diagram form in order to facilitate description.

The present invention provides a method, apparatus, and article of manufacture for targeting information content in overlapping sales territories. This information content may be for example, advertising, announcements, or inventory data. A preferred embodiment wherein the information content is advertising, e.g. advertisements, is described. In one embodiment, a user accesses a web site and is assigned a cobrand. The cobrand is assigned based upon a uniform resource locator (URL) received during access of the web site. If the URL corresponds to cobrand, the user may be assigned an explicit cobrand. If the information does not correspond to a cobrand, the user may be assigned an implicit cobrand. Advertising content based upon the assigned cobrand may be selected and displayed to the user.

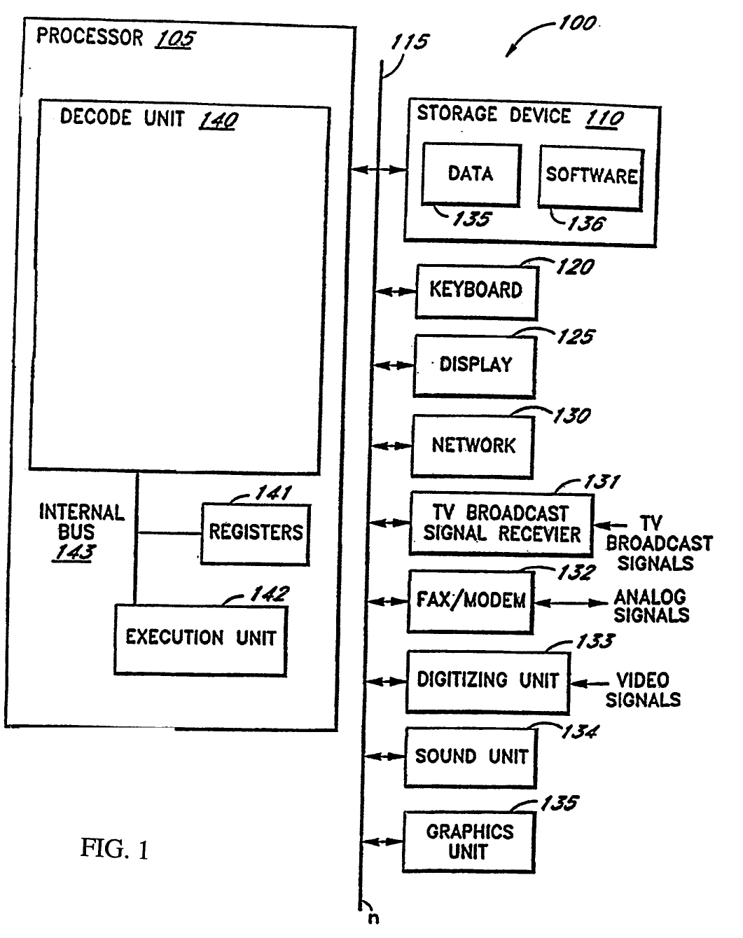

FIG. 1 illustrates one embodiment of a computer system 100 which implements the principles of the present invention. Computer system 100 comprises a processor 105, a storage device 110, and a bus 115. The processor 105 is coupled to the storage device 110 by the bus 115. In addition, a number of user input/output devices, such as a keyboard 120 and a display 125, are also coupled to the bus 115. The processor 105 could be implemented on one or more chips. The storage device 110 represents one or more mechanism for storing data. For example, the storage device 110 may include read only memory (ROM), random access memory (RAM), magnetic disk storage mediums, optical storage mediums, flash memory devices, and/or other machine-readable mediums. The bus 115 represents one or more buses (e.g., AGP, PCI, ISA, X-Bus, VESA, etc.) and bridges (also termed as bus controllers). While this embodiment is described in relation to a single processor computer system, the invention could be implemented in a multi-processor computer system.

In addition to other devices, one or more of a network 130, a TV broadcast signal receiver 131, a fax/modem 132, a digitizing unit 133, a sound unit 134, and a graphics unit 135 may optionally be coupled to bus 115. The network 130 and fax modem 132 represent one or more network connections for transmitting data over a machine readable media (e.g., carrier waves). The digitizing unit 133 represents one or more devices for digitizing images (i.e., a scanner, camera, etc.). The sound unit 134 represents one or more devices for inputting and/or outputting sound (e.g., microphones, speakers, magnetic storage devices, optical storage devices, etc.). The graphics unit 135 represents one or more devices for generating 3-D images (e.g., graphics card).

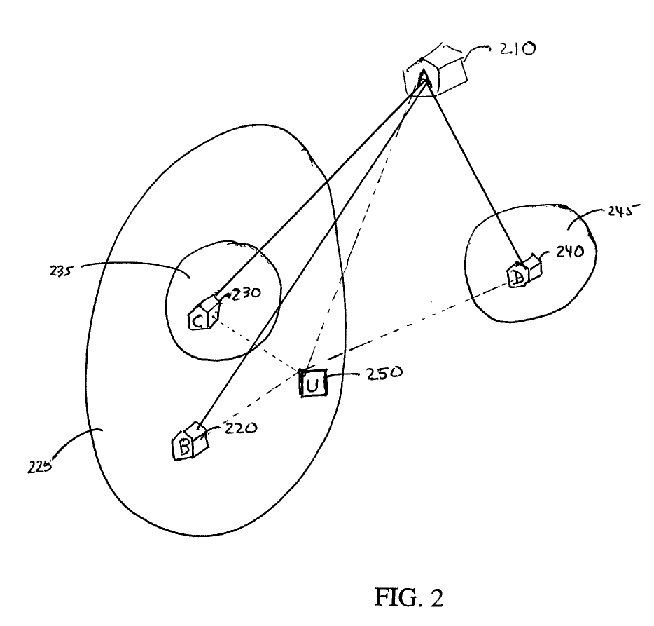

FIG. 1 also illustrates that the storage device 110 has stored therein data 135 and software 136. Data 135 represents data stored in one or more of the formats described herein. Software 136 represents the necessary code for performing any and/or all of the techniques described with reference to FIGS. 2-7. It will be recognized by one of ordinary skill in the art that the storage device 110 preferably contains additional software (not shown), which is not necessary to understanding the invention.

FIG. 1 additionally illustrates that the processor 105 includes decode unit 140, a set of registers 141, and execution unit 142, and an internal bus 143 for executing instructions. It will be recognized by one of ordinary skill in the art that the processor 105 contains additional circuitry, which is not necessary to understanding the invention. The decode unit 140, registers 141 and execution unit 142 are coupled together by internal bus 143. The decode unit 140 is used for decoding instructions received by processor 105 into control signals and/or microcode entry points. In response to these control signals and/or microcode entry points, the execution unit 142 performs the appropriate operations. The decode unit 140 may be implemented using any number of different mechanisms (e.g., a look-up table, a hardware implementation, a PLA, etc.). While the decoding of the various instructions is represented herein by a series of if/then statements, it is understood that the execution of an instruction does not require a serial processing of these if/then statements. Rather, any mechanism for logically performing this if/then processing is considered to be within the scope of the implementation of the invention.

The registers 141 represent a storage area on processor 105 for storing information, including control/status information, integer data, floating point data, and packed data. The term data processing system is used herein to refer to any machine for processing data, including the computer system(s) described with reference to FIG. 1.

FIG. 2 is a diagram 200 illustrating one context in which one embodiment of the present invention may be used for targeting advertising in overlapping sales territories. In one example, an advertising company Alpha, A, displays advertising on a web site. The advertising company Alpha can be a business which maintains an Internet web site that can be linked with other Internet web sites as well as accessed directly. The advertising company Alpha can display advertisements for a partner, or for other organizations, companies, businesses, or individuals that the partner is advertising.

In one example, the advertising company Alpha provides the display of advertisements on the Alpha web site 210 for itself and the group of partners, Beta, Chi, and Delta, respectively B, C, and D, in response to a user access of the Alpha web site 210. The partners, Beta, Chi, and Delta typically sell advertisements to one or more businesses. For example, the advertisements may include, but are not limited to, product and service advertisements, fax and communication packages, enhanced advertisement packages, and inventory packages.

A partner can be another organization, company, business or individual whose advertisements are displayed by the advertising company. Each partner has one or more defined geographic sales territories which may be by country, state, county, city, zip code, or other geographic area. The one or more sales territories of one partner may overlap with one or more sales territories of other partners. For example, partner Beta, may have a sales territory 225 which encompasses the San Francisco bay area; partner Chi, may have a sales territory 235 which encompasses the city of San Francisco, and, partner Delta, may have a sales territory 245 which encompasses the Lake Tahoe area. The sales territories of partner Beta and Chi overlap in that the San Francisco bay area is inclusive of San Francisco.

Typically, a User with Internet access, such as computer 250, accesses the web site 210 either directly over the Internet or indirectly via a link from a partner web site 220, 230 or 240 to the Alpha web site 210. Generally, the User accesses one of the web sites 210, 220, 230, or 240 and enters a search query for a particular type of information. For example, the user may enter a search query for a business, business category, or may use a key word. Advertisements appropriate to the subject matter of the request and to the geographic area are then displayed to the User. It will be recognized by one of ordinary skill in the art that the above example is merely illustrative and is not intended to limit the number of partners, number of partner web sites, the number of users, or the manner in which a user accesses the web sites.

Before advertisements can be displayed to a user, one or more databases may be established which associate partners with their respective advertisements. In one embodiment of the present invention, an advertising database is developed as described below.

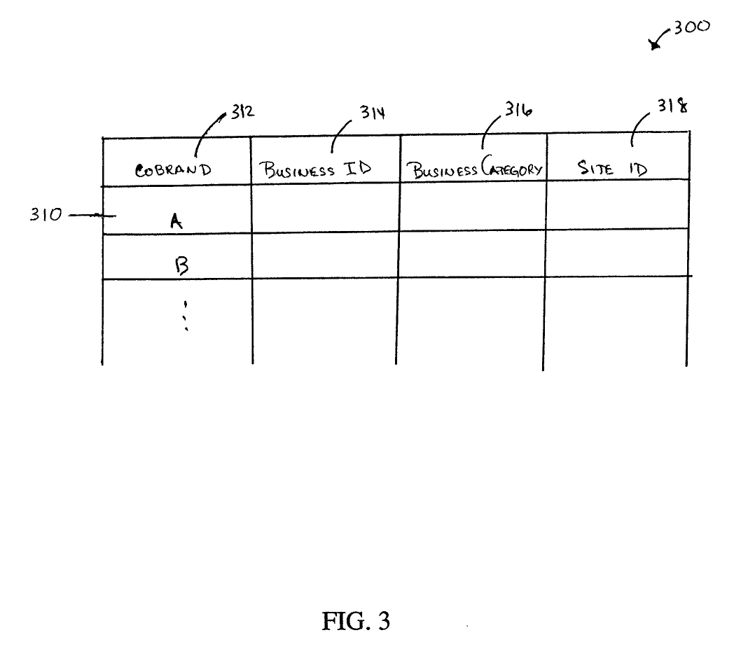

FIG. 3 illustrates an example of an advertising table 300 according to one embodiment of the present invention. In the advertising table 300, each advertisement 310 is entered as a separate record with information that identifies the partner that owns or sold the advertisement. Examples of information that can be entered as part of an advertisement 310 are a cobrand 312, a business identifier 314, a business category 316, and a site identifier 314. It is to be understood by one of ordinary skill in the art that the aforementioned information may or may not be present, and that additional information may be required to accommodate the record needs of an advertisement, for example, sales territory, or region information.

The cobrand 312 may be a name, or identifier, assigned to a partner. A partner can have more than one cobrand assigned. In one embodiment, the cobrand 312 may be 32 alphanumeric characters. In one embodiment, the cobrand 312 may also be the cobrand directory name of a cobrand directory location which contains files associated with the cobrand 312. The business identifier 314 may be a particular business name; for example, “San Francisco Motorville BMW”. The business category 316 may be a particular business type; for example, “BMW”. A business identifier 314 can have multiple business categories 316; for example, “BMW”, “Auto Parts”, and “Automobiles”. The site identifier 318 may indicate the web site associated with the business identifier 314.

As described above, in one embodiment, the cobrand 312 may also be the cobrand directory name of a cobrand directory location which contains files associated with the cobrand 312. For example, a cobrand directory name and cobrand directory location may be established for every cobrand 312 associated with Alpha and the partners Beta, Chi and Delta. In one embodiment, each cobrand directory location associated with the cobrand directory name may contain a cobrand context file. It is to be understood by one of ordinary skill in the art that other files may also be contained within each directory.

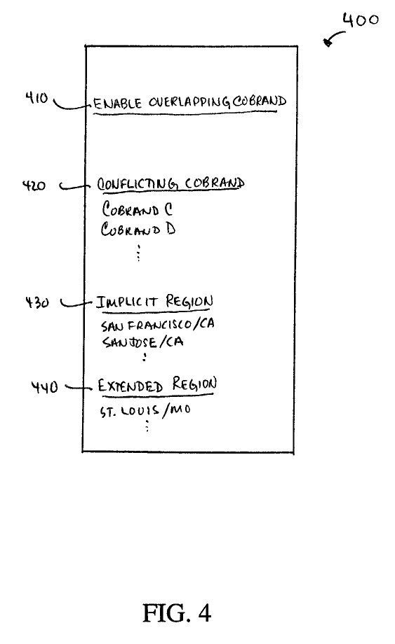

FIG. 4 illustrates an example of a cobrand context file 400 according to one embodiment of the present invention. In one embodiment, each cobrand context file 400 may contain an enable overlapping cobrand instruction 410, a conflicting cobrand category 420 and an implicit region listing 430 and an extended region listing 440. The enable overlapping cobrand instruction 410 can be a logical value, for example, a Boolean argument, which may enable or disable access to a list of competing cobrands listed in the conflicting cobrand category 420. In one embodiment, when access to the conflicting cobrand category 420 is enabled, advertisements for competing cobrands represented in the conflicting cobrand 420 category may not be displayed to a user. When access to the conflicting cobrand category 420 is disabled, advertisements for competing cobrands listed in the conflicting cobrand 420 category may be displayed to a user. It is to be understood by one of ordinary skill in the art that different settings are possible, as well as, inclusion of different logic structures for determination of whether to exclude advertisements of competing cobrands.

Additionally, each cobrand context file may contain an implicit region list 430 and an extended region list 440 that together may contain a list of sales territories, or regions, where sale of the cobrand advertisements is permitted. The implicit region list 430 may contain a list of sales territories, or regions, where the cobrand may be assigned as an implicit cobrand and advertisements associated with the cobrand displayed to a user. The extended region list 440 may contain a list of sales territories, or regions, where sale of the cobrand advertisements is permitted, but where the cobrand may not be assigned as an implicit cobrand.

Other databases may also be established for advertising reference. For example, a business details table may be developed to include data such as the partner name, address, and phone number. In one embodiment, the data may include an identifier which links an advertisement to the owning business. In one embodiment, the data in the table is consistent across all partners and can be modified by any partner or the advertising company.

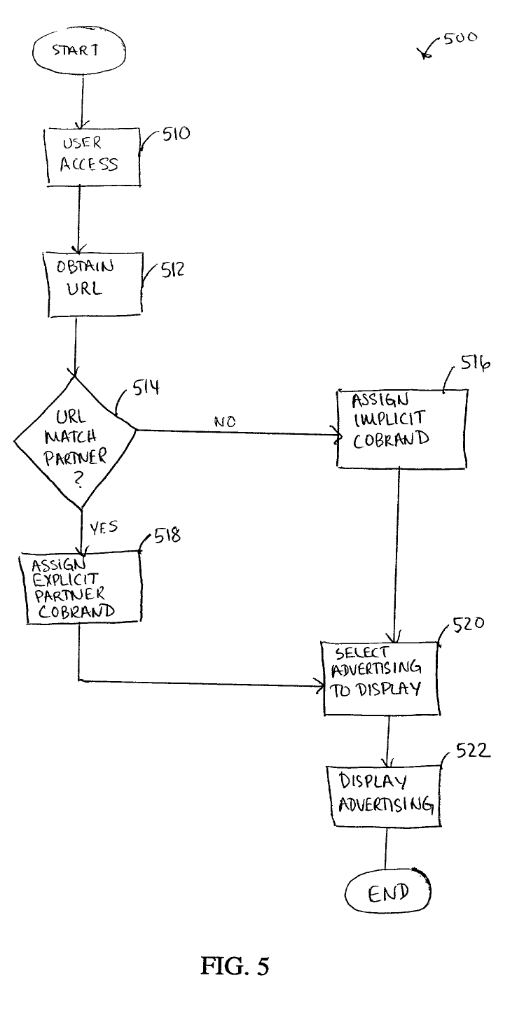

FIG. 5 illustrates a flow diagram 500 of one embodiment of the method of the present invention which targets advertising in overlapping sales territories. At step 510 a user accesses the advertising company web site 210. As earlier discussed, the user may access the web site 210 either directly or indirectly via a link from a partner web site 220, 230, or 240. If the user accesses the web site 210 directly, the access is designated implicit. If the user accesses the web site 210 via a link from a partner's web site, the access is designated explicit.

When a user accesses the web site 210, data containing a URL is received at the advertising web site 210. In one embodiment, a portion of the URL may contain information that may correspond to a cobrand. In one embodiment, this information may be a cobrand name. At step 512, the information may be extracted from the URL.

At step 514, the information may be compared to the cobrand directory names listed in the cobrand directory for a matching cobrand name. If a matching cobrand name is not found, at step 516, the system may assign the user the cobrand of the advertising company Alpha. It will be recognized by one of ordinary skill in the art that a partner cobrand may instead be assigned. At step 518, if a matching cobrand name is found, the user may be assigned that explicit cobrand. At step 520, advertising associated with the assigned cobrand may be selected for display to the user. At step 522, the selected advertising may be displayed to the user.

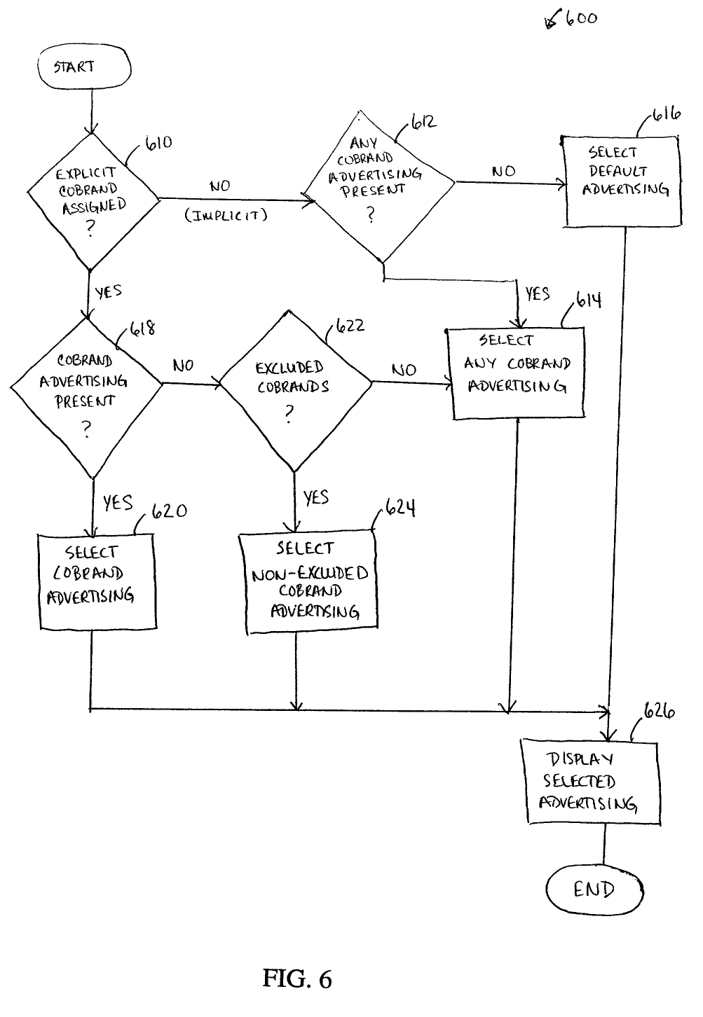

FIG. 6 illustrates a flow diagram 600 of one embodiment of a method of the present invention for selecting the advertising, e.g. an advertisement, to display to a user. When a user is assigned a cobrand, the advertising table 300 can be searched to determine if the assigned cobrand has advertising relating to the search query, and if competing cobrand advertisements should be excluded from display.

At step 610, a determination is made whether the assigned cobrand is implicit or explicit. If the assigned cobrand is implicit, at step 612, the advertising table 300 is searched to determine if any cobrand advertising is present which is responsive to the user's search query. The user search query may contain a request for information relating to a business, a business category, geographic region, or a keyword. It is to be understood by one of ordinary skill in the art that additional types of information may also be queried and that the advertising table 300 may include different categories or be used in conjunction with other databases or files, such as the context files, which allow searches for cobrands that are responsive to the query. For example, geographic information, sales territories, or region listings.

At step 614, if advertising is present that is responsive to the user's search query, then advertising of any partner cobrand responsive to the query may be selected. The selection of the advertising from among the cobrands may be made on a specified basis, for example, a rotational basis, a weighted basis, or a random basis. It will be recognized by one of ordinary skill in the art that the above examples of a specified basis are not all inclusive and are not intended as limiting. At step 626, the selected advertising is displayed to the user.

If cobrand advertising is not present which is responsive to the user's query, at step 616, default advertising may be selected. For example, the cobrand of advertising company Alpha may be assigned so that advertising for company Alpha may be selected. It will be recognized by one of ordinary skill in the art that other default selections can be provided. For example, a default selection may be to select advertising from among partner cobrands on a specified basis, such as a rotational basis, a weighted basis, or random basis. At step 626, the selected advertising is displayed to the user.

If the assigned cobrand was explicit, at step 618, the advertising table 300 may be searched to determine if any advertising for the assigned explicit cobrand is present which is responsive to the user's search query. As earlier described, the user search query may contain a request for information relating to a business, a business category, or a keyword. It is to be understood by one of ordinary skill in the art that additional types of information may also be queried and that the advertising table 300 may include different categories or be used in conjunction with other databases or files, such as the context files, which allow searches for cobrands that are responsive to the query. For example, geographic information, sales territories, or region listings. If the assigned explicit cobrand has advertising that is responsive to the user's search query, at step 620, advertising of the assigned explicit cobrand is selected. At step 626, the selected advertising is displayed to the user.

If the assigned explicit cobrand has no advertising that is responsive to the user's search query, advertising of any cobrand responsive to the user's query may be selected for display to the user, unless that cobrand is found in the conflicting cobrand 420 list of the context file 400 of the assigned cobrand and the enable overlapping cobrand 410 logic argument was set to exclude selection of competing cobrands. At step 622, the context file 400 of the assigned explicit cobrand may be evaluated to determine if other cobrands may be searched and selected for display if responsive to the user's search query. If competing cobrands are to be excluded, at step 624, the advertising of a non-competing, e.g. non-excluded, cobrand responsive to the user's search query is selected. The selection of the advertising from among the non-competing cobrands may be made on a specified basis, for example, a rotational basis, a weighted basis, or a random basis. At step 626, the selected advertising is displayed to the user.

If competing cobrands are not to be excluded from selection and display to the user, at step 614, advertising of any cobrand responsive to the user's search query may be selected. The selection of the advertising from among the cobrands may be made on a specified basis, for example, a rotational basis, a weighted basis, or a random basis. At step 626, the selected advertising is displayed to the user.

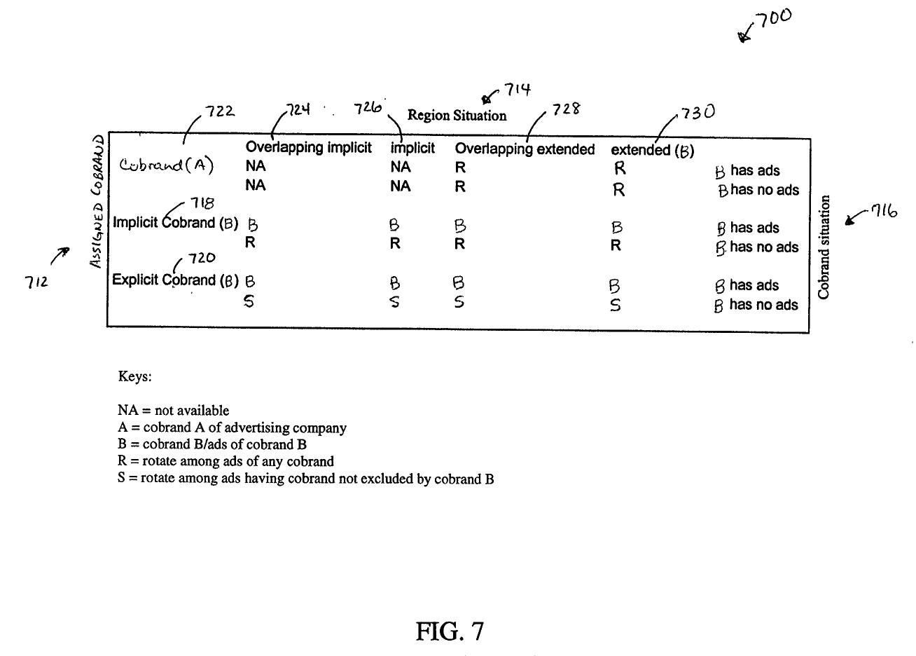

FIG. 7 illustrates a table 700 of one embodiment of a method of the present invention for selecting the advertising, e.g. an advertisement, to display to a user when competing cobrands are not excluded. Selection of the advertising is based upon a consideration of the assigned cobrand 712, the region situation 714, and the cobrand situation 716.

In one embodiment, the assigned cobrand 712 may be an implicit cobrand 718, an explicit cobrand 720, or if no matching cobrand was identified, the cobrand 722 of advertising company Alpha may be assigned.

In one embodiment, the region situation 714 may be described as an overlapping implicit region 724, an implicit region 726, an overlapping extended region 728, or an extended region 730. In one embodiment, the overlapping implicit region 724 designation describes a situation in which a particular geographic region associated with a user search query is listed in more than one cobrand implicit region list 430 of a context file. For example, if a user is to be assigned an implicit cobrand, and the user requested a search query be limited to San Francisco, Calif., the assignment of an implicit cobrand can be made from among the cobrands listing that region, i.e., San Francisco, Calif., in the implicit region list 430 of the context file.

In one embodiment, the implicit region 726 designation describes a situation in which a particular geographic region associated with a user search query is listed in one cobrand implicit region list 430 of a context file. For example, if a user is to be assigned an implicit cobrand, and the user requested a search query be limited to San Francisco, Calif., the assignment of an implicit cobrand will be the cobrand of the one cobrand listing that region, i.e., San Francisco, Calif., in the implicit region list 430 of the context file.

In one embodiment, the overlapping extended region 728 designation describes a situation in which more than one cobrand may have advertisements sold in particular region listed in the extended region list 440 that is responsive to a user search query specifying that region; however, those cobrands may not be assigned as an implicit cobrand. For example, more than one partner has an established sales territory listed in the implicit region list 430 that does not include San Diego or Los Angeles, Calif. However, these partners also sell advertisements in San Diego and Los Angeles whenever the respective football teams of those cities are scheduled to play cities in the partners established sales territories. The areas of San Diego and Los Angeles, Calif., are outside the established partner sales territories listed in the implicit region lists 430, and are listed instead in the extended region lists 440. Thus, if a user is to be assigned an implicit cobrand, and the user search query included a region parameter specifying San Diego, the cobrands of the partners listing San Diego, Calif., in the extended region list 440 will not be assigned as an implicit cobrand. Instead, the implicit cobrand assigned to the user may be from among the cobrands listing San Diego, Calif., in the implicit region list 430. In another example, if the user does not specify a region parameter, or the user access was explicit, i.e., via the partner web site 220, the partner cobrand(s) listing the region listed in extended region list 44) may be assigned to the user.

In one embodiment, the extended region 730 designation describes a situation in which one cobrand may have advertisements sold in particular region listed in the extended region list 440 that is responsive to a user search query specifying that region; however, the partner cobrand may not be assigned as an implicit cobrand. For example, a partner has an established sales territory of San Francisco, Calif., listed in the implicit region list 430 that does not include San Diego or Los Angeles, Calif. However, the partner also sells advertisements in San Diego, and Los Angeles whenever the respective football teams of those cities are scheduled to play San Francisco. The regions of San Diego and Los Angeles, Calif., are outside the established partner sales territory listed in the implicit region list 430, and are listed instead in the extended region list 440. Thus, if a user is to be assigned an implicit cobrand, and the user search query included a region parameter specifying San Diego, Calif., the cobrand of the partner will not be assigned as an implicit cobrand. Instead, the implicit cobrand assigned to the user may be from among the cobrands listing San Diego, Calif., in the implicit region list 430. In another example, if the user does not specify a region parameter, or the user access was explicit, i.e., via the partner web site 220, the partner cobrand listing the region in the extended region list 440 may be assigned to the user.

In one embodiment, the cobrand situation 716, may be described by the presence or absence of advertising for a cobrand in the advertising table 300.

In one example, a user may indirectly access the advertising company Alpha's web site 210 from a partner web site 220 which is owned by partner Beta, B. The URL of the web site 220 is evaluated for information corresponding to a cobrand name. The information may be extracted and compared to the directory of cobrand names. If the information matches a cobrand name, the explicit cobrand of that cobrand name is assigned. For example, if a cobrand name obtained from a URL is matched to the cobrand of partner Beta, the explicit cobrand (B) 720 may be assigned to the user. If explicit cobrand (B) 720 has advertising, ads, present in the advertising table 300, the advertising of cobrand (B) 720 may be displayed to the user with consideration of the region situation. If cobrand (B)720 has no advertising present in the advertising table 300, advertising of any of the other partner cobrand, unless excluded, may be selected and displayed to a user on a rotational basis with consideration of the region situation. It will be recognized by one of ordinary skill in the art, that bases other than rotational may be used, including but not limited to a random basis or a weighted basis.

In another example, a user may directly access the advertising company Alpha's web site 210. The implicit cobrand (B) 718 may be assigned to the user based upon the user's search query and the region situation as earlier described. If cobrand (B) 718 has advertising present in the advertising table 300, the advertising of cobrand (B) 718 may be displayed to the user with consideration of the region situation. If cobrand (B) 718 had no advertising present in the advertising table 300, the advertising of any other partner cobrand may be displayed on a rotational basis with consideration of the region situation. It will be recognized by one of ordinary skill in the art, that bases other than rotational may be used, including but not limited to a random basis or a weighted basis.

In a further example, a user may either directly or indirectly access the advertising company Alpha's web site 210 and Alpha's cobrand (A) 722 may be assigned. For example, the assignment of Alpha's cobrand (A) 722 may be responsive to the user's search query or a default selection. In this situation, although a default advertisement for Alpha may be shown, the advertising of any other partner cobrand may instead be displayed on a rotational basis with consideration of the region situation. It will be recognized by one of ordinary skill in the art, that bases other than rotational may be used, including but not limited to a random basis or a weighted basis.

In this manner, targeted advertising of several partners with overlapping sales territories can be displayed to a user. While the present invention has been above described in terms of its use in targeting advertising, the present invention may also be used with other applications, such as inventory control.

In one embodiment, a database similar to those described above can be developed. Categories can be established which list an identifier representative of a partner that owns the inventory. Each partner can specify a geographic region, for example, a city, to which the inventory is assigned. Inventory may be entered into the database and marked as belonging to a partner when it enters the inventory system.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting on the invention.

What is claimed is:

1. A method for targeting information content to a user accessing a web site comprising the steps of:
assigning a cobrand to the user;
selecting information content based upon the assigned cobrand; and
displaying the information content.

2. The method of claim 1 wherein the information content is advertising content.

3. The method of claim 1 wherein the step of assigning a cobrand to a user further comprises the steps of:
receiving data from the user containing a uniform resource locator;
determining the uniform resource locator (URL) from the data; and
assigning a cobrand to the user based on the determined URL.

4. The method of claim 3 wherein the step of assigning a cobrand to the user based on the determined URL further comprises the step of:
assigning an implicit cobrand to the user if the determined URL does not correspond to a cobrand.

5. The method of claim 3 wherein the step of assigning a cobrand to the user based on the determined URL further comprises the step of:
assigning an explicit cobrand to the user if the determined URL corresponds to a cobrand.

6. The method of claim 4 wherein selecting information content based upon the assigned cobrand further comprises the step of:
selecting information content of any known cobrand.

7. The method of claim 6 wherein selecting information content of any cobrand is on a specified basis.

8. The method of claim 5 wherein the step of assigning an explicit cobrand to a user further comprises the step of:
assigning the corresponding cobrand.

9. The method of claim 8 wherein the step of selecting information content based upon the assigned cobrand further comprises the step of:
if the assigned cobrand information content exists, selecting information content of the assigned cobrand.

10. The method of claim 8 wherein the step of selecting information content based upon the assigned cobrand further comprises the step of:
if the assigned cobrand information content does not exist, determining if excluded cobrands exist.

11. The method of claim 10 wherein the step of determining if excluded cobrands exist further comprises the step of:
accessing the context file of the assigned cobrand to determine if competing cobrands are listed.

12. The method of claim 11 wherein the step of selecting information content based upon the assigned cobrand further comprises the step of:
if excluded cobrands exist, selecting information content of a non-excluded cobrand.

13. The method of claim 11 wherein the step of selecting information content based upon the assigned cobrand further comprises the step of:
if excluded cobrands do not exist, selecting information content of any cobrand.

14. The method of claim 12 wherein selecting information content of a non-excluded cobrand is on a specified basis.

15. The method of claim 13 wherein selecting information content of any cobrand is on a specified basis.

16. An apparatus for targeting information content comprising:
a data receiver to receive data representing a user accessing a web site;
a processor logically coupled to the data receiver; and
a storage device logically coupled to the processor and having stored therein a routine, which when executed by the processor, causes the processor to at least,
assign a cobrand to a user;
select information content based upon the assigned cobrand;
display the selected information content to the user.

17. The apparatus of claim 16 wherein the storage device further causes the processor to:
determine a uniform resource locator (URL) from the received data; and
assign a cobrand to the user based on the determined URL.

18. The apparatus of claim 17 wherein the storage device further causes the processor to:
assign an implicit cobrand to a user if the determined URL does not correspond to a cobrand.

19. The apparatus of claim 17 wherein the storage device further causes the processor to:
assign an explicit cobrand to a user if the determined URL corresponds to a cobrand.

20. An article of manufacture for use in a computer system, the article of manufacture comprising a computer usable medium having computer readable program code means embodied in the medium, the program code means including:
computer readable program code means embodied in the computer usable medium for causing a computer to assign a cobrand to a user;
computer readable program code means embodied in the computer usable medium for causing a computer to select information content based upon the assigned cobrand; and
computer readable program code means embodied in the computer usable medium for causing a computer to display the selected information content.

21. The article of manufacture of claim 20, the computer readable program code means for causing a computer to assign a cobrand to a user further including:
computer readable program code means embodied in the computer usable medium for causing a computer to receive data from a user containing a uniform resource locator (URL);
computer readable program means embodied in the computer usable medium for causing a computer to determine the URL from the received data; and
computer readable program code means embodied in the computer usable medium for causing a computer to assign a cobrand based upon the determined URL.

22. The article of manufacture of claim 21, the computer readable program code means for causing a computer to assign a cobrand based upon the determined URL further including:
computer readable program code means embodied in the computer usable medium for causing a computer to assign an implicit cobrand to a user if the determined URL does not correspond to a cobrand.

23. The article of manufacture of claim 21, the computer readable program code means for causing a computer to assign a cobrand based upon the determined URL further including:
computer readable program code means embodied in the computer usable medium for causing a computer to assign an explicit cobrand to a user if the determined URL corresponds to a cobrand.

24. An apparatus for targeting information content comprising:
a means for receiving data representing a user accessing a web site;
a means for assigning a cobrand to a user;
a means for selecting information content based upon the assigned cobrand; and
a means for displaying the selected information content to the user.

25. The apparatus of claim 24 wherein the means for assigning a cobrand to a user further comprises:
a means for determining a uniform resource locator (URL) from the received data; and
a means for assigning a cobrand to the user based on the determined URL.

26. The apparatus of claim 25 wherein the means for assigning a cobrand to the user based on the determined URL further comprises:
a means for assigning an implicit cobrand to a user if the determined URL does not correspond to a cobrand.

27. The apparatus of claim 25 wherein the means for assigning a cobrand to the user based on the determined URL further comprises:
a means for assigning an explicit cobrand to a user if the determined URL corresponds to a cobrand.
